(19) United States
(12) Patent Application Publication
(10) Pub. No.: US 2012/0234447 A1
(43) Pub. Date: Sep. 20, 2012

(54) Automatic tire inflation system

(76) Inventors: Andrew Joseph Narloch, Walnut Creek, CA (US); Joseph Andrew Narloch, Walnut Creek, CA (US)

(21) Appl. No.: 13/065,213

(22) Filed: Mar. 17, 2011

(51) Int. Cl. B60C 23/10

(52) U.S. Cl. 152/418

(57) ABSTRACT

An automatic tire inflation system including an air pump, a pressure sensor, a microprocessor and a rechargeable battery power supply all housed in a water resistant housing. The housing conforms to the diameter of the rim of a standard vehicle tire and is held to the tire by rim retaining fingers. A recharging jack is mounted inside the housing and is accessed through an aperture on the housing which is sealed by a removable waterproof cover. The microprocessor monitors air tire pressure being sent from the pressure sensor and activates the air pump when the pressure is determined to be too low by the microprocessor. The air pump turns off when the air tire pressure reaches a predetermined set point. The rechargeable battery is recharged by a standard charging device attached by a plug to the recharging jack. Similar automatic tire inflation systems can be mounted to each tire of the vehicle.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of automotive accessories and more specifically to an automatic tire inflation system.

Pneumatic vehicle tires must be kept at a recommended pressure in order to perform optimally. If pressure is too low, the vehicle may not handle fast turns well. Additionally, low air pressure results in reduced gas mileage. It is therefore recommended that a person maintain optimal tire pressure at all times while driving. However, many drivers do not take the time to read tire pressure of each tire and add air as needed.

It would therefore be an advantage to automatically pressurize the tire as needed to keep it at its ideal inflation pressure. A number of inventors have addressed this problem. Some of them have proposed solutions that use the rotation of the tire to create a pumping action within the tire and thereby pressurize it. These include U.S. Pat. Nos. 4,154,279 and 5,556,489 and 5,591,281 and 5,667,606 and 5,975,174. These designs rely on mechanisms located both inside the tire and outside the tire that, when put to practice, would be expensive and prone to breakdown due to the extreme temperature and vibration conditions that most tires go through during use. Another way to have a battery powered air pump attached in some way to the tire that would inflate the tire when a pressure sensor indicates that the pressure is low. Such a design was patented by Loewe et al in U.S. Pat. No. 5,928,444—now expired. However, there are deficiencies in the Loewe design. First, the pump and battery mechanism is housed within the wheel cover. This means that the wheel cover must be custom designed for each type of tire and vehicle and therefore is not easy to retrofit onto an existing vehicle. Second, motion is detected by a centrifugal intake valve. A motion detection is desired so that the pressure sensor is only working when the car is in motion. However, a centrifugal intake valve is a costly way to detect motion and a possible way to incur air leakage problems. Third, no provision is made to equalize the weight of the components to prevent wheel imbalance. Fourth, no provision is made to be able to recharge the batteries located inside the wheel cover, meaning that the user would have to open the housing each time the batteries needed to be changed.

### BRIEF SUMMARY OF THE INVENTION

The primary object of the invention is to provide an automatic tire inflation system that can be attached to the rim of a standard vehicle tire.

Another object of the invention is to provide an automatic tire inflation system that senses tire pressure and, if too low, provides pressurized air from an air pump until the correct pressure is reached.

Another object of the invention is to provide an automatic tire inflation system that transmits tire pressure information to the driver inside the vehicle.

A further object of the invention is to provide an automatic tire inflation system whose housing is water resistant and vibration resistant.

Yet another object of the invention is to provide an automatic tire inflation system that, when installed on a tire, does not affect the balance of the tire.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an automatic tire inflation system comprising: a battery powered air pump, an air pump electrical cable, a pneumatic stem connector, a pressure sensor switch, a pressure sensor switch electrical cable, a rechargeable battery power supply, a recharging jack, a waterproof jack cover, a battery cable, a microprocessor, a printed circuit board a motion sensor switch, a water resistant air filter, a counter weight, a water resistant hollow housing, a plurality of rim retaining fingers, said stem connector attached at one end to the stem of a standard vehicle tire and at the other end to said tire pressure switch, said tire pressure switch pneumatically connected to said air pump, said pressure sensor switch electrical cable connected to said microprocessor, said microprocessor mounted to said printed circuit board, said battery cable attached to said microprocessor, said air pump cable attached to said microprocessor, said motion sensing switch mounted to said printed circuit board, said hollow housing having an outside diameter conforming to the inside diameter of the rim of said vehicle tire, said hollow housing having two major diametrically opposed portions connected by radial hollow track, said hollow housing connected to said tire rim by said rim retaining fingers, said air pump and said pressure switch housed in one said major housing portion, said battery power supply and said printed circuit board with attached said components mounted on said opposing major housing portion, said counter weight housed in the same said housing portion that contains said air pump, said counter weight being sized to make the weight of said air pump housing portion equal to that of said battery containing housing portion, said housing having a uniform height from said tire rim on both said major housing portions and on said connecting radial hollow tracks, said housing having an aperture that accepts said recharging jack, said aperture and said recharging jack having a removable and replaceable waterproof cover, said housing having an air passage aperture, said water resistant air filter inserted into said air passage aperture, said motion sensor switch sensing when the vehicle is in motion and turning on said microprocessor, said microprocessor monitoring air tire pressure being sent from said pressure sensor and activating said air pump when said pressure is determined to be too low by said microprocessor, said air pump turning off when said air tire pressure reaches a predetermined set point, said rechargeable battery capable of being recharged by a standard charging device attached by a plug to said recharging receptacle, and said vehicle having similar automatic tire inflation systems mounted to each tire of the vehicle

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of a typical pneumatic tire and rim attached to a standard vehicle invention.

FIG. 2 is a perspective view of the present invention mounted to the rim of a standard vehicle tire assembly.

FIG. 3 is a plan view of vehicle tire with the invention mounted to the rim.

FIG. 4 is a side section view of the invention mounted to the rim of a standard vehicle tire assembly.

FIG. 5 is a section view of the pump housing portion of the invention.

FIG. 6 is a section view of the battery holding housing portion of the invention.

FIG. 7 is a schematic view of the invention.

FIG. 8 is a section view of an alternate embodiment of the invention.

FIG. 9 is a perspective view of the alternate embodiment of the invention.

FIG. 10 is a perspective view of the alternate embodiment in place on a vehicle tire rim.

FIG. 11 is a section view of a second alternate embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

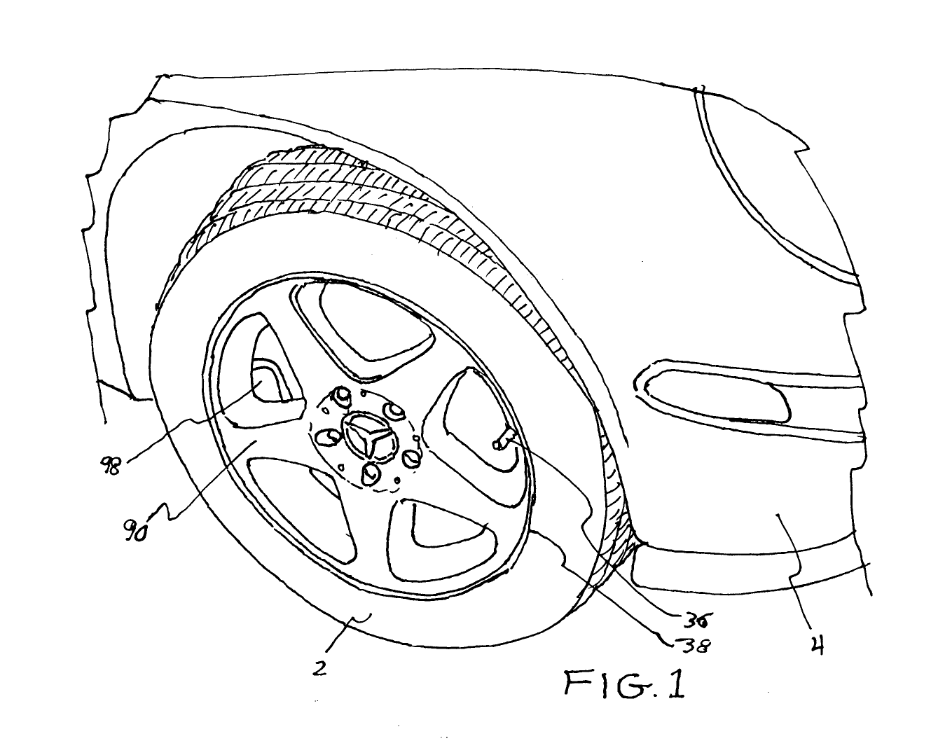

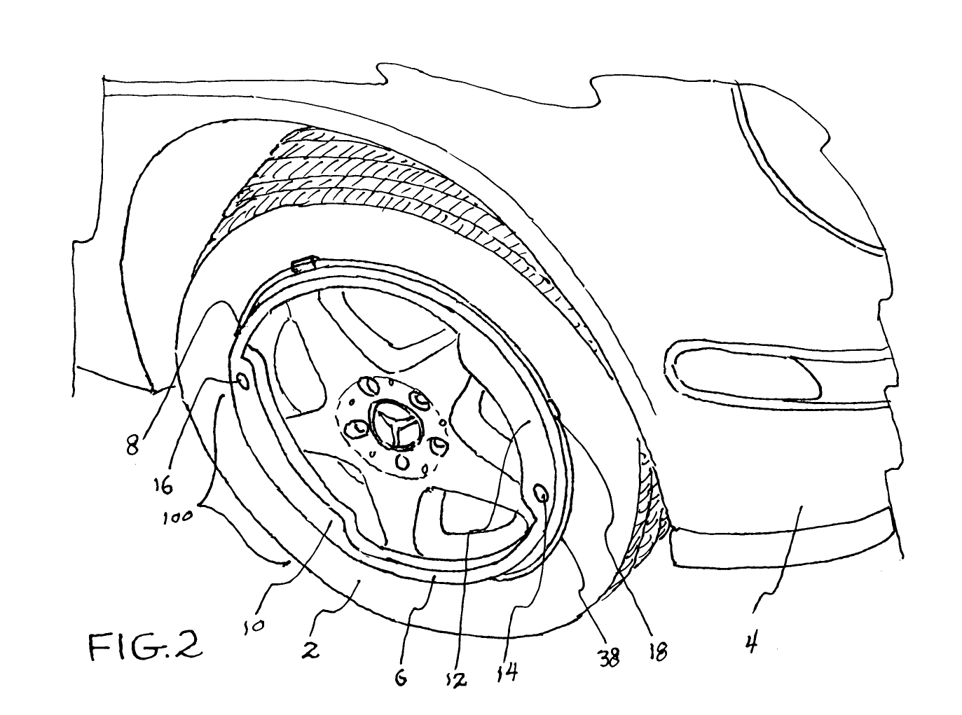

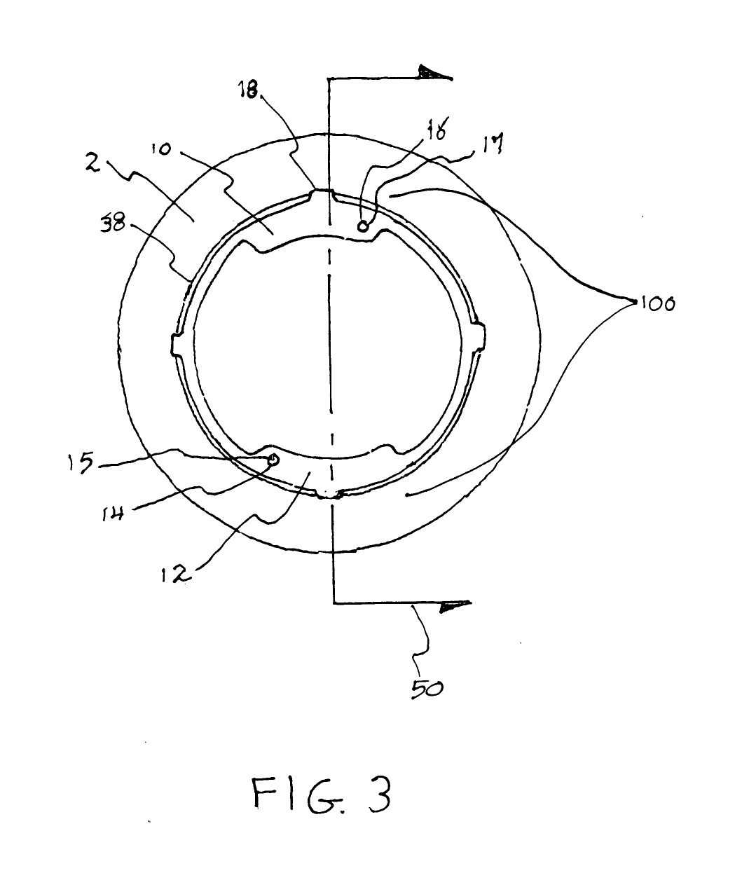

Referring now to FIG. 1 we see a standard tire 2 attached in a standard way to a vehicle 4. A standard rim 36 and rim support structure 90 can be seen as well as a standard air input valve 36 and brake mechanism 98. FIG. 2 shows the same tire 2 with the present invention 100 attached to the rim 38 via rim retaining fingers 18. The housing of the invention is comprised of two major portions 10, 12 connected by two hollow track portions 6, 8. Major portion 10 holds an air pump 30 and pressure sensor 28. Major portion 12 holds a battery pack 20 and printed circuit board 40. Hollow track 8 houses electrical cables that go from the pump 30 and sensor 28 to the printed circuit board 40 located in housing portion 12. Hollow track 6 houses electrical cables that attach the battery pack 20 to the pump 30. FIG. 3 shows a plan view of a tire 2 and rim 38 with the invention 100 mounted to it via integral clips 18 that fasten to the rim 38. Other versions of the invention 100 can be sized to fit other standard rim dimensions. Aperture 15 is closed by removable rubber cap 14. Aperture 16 houses a finely porous material 17 that allows air through but not water, such the product “Porex”. The rest of the housing is water and dirt resistant.

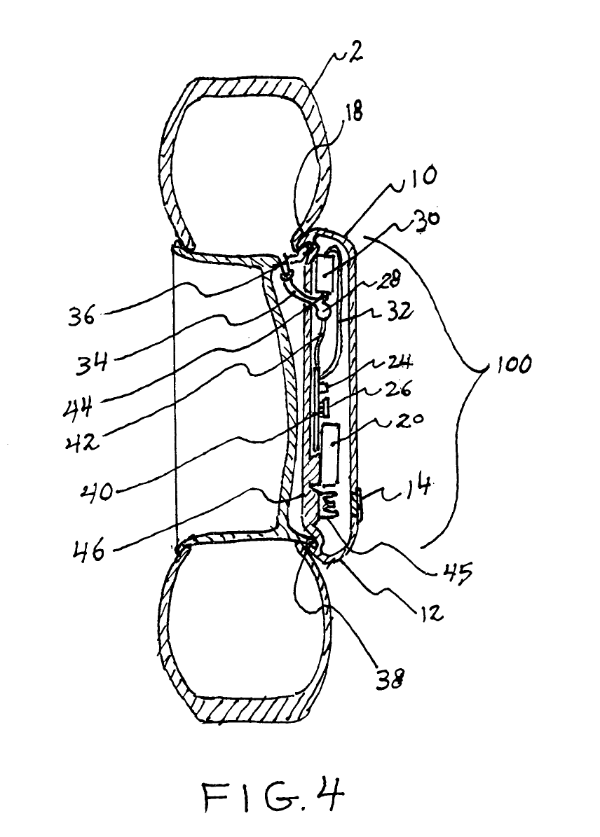

FIG. 4 shows a section view of the invention 100 that bisects the tire 2 as defined by section line 50 in FIG. 3. The housing is attached to the rim 38 via rim retaining fingers 18. The housing is comprised of rear wall 46 and front walls that form major portions 10, 12 and hollow tracks 6, 8. Standard tire stem 36 is connected to a pressure sensor switch 28 via connector tube 34. The pressure sensor 28 is also connected via air tube 44 to air pump 16. Electrical cable 44 connects the pressure sensor switch 28 to printed circuit board 40. Water resistant cap covers recharging jack 45. Rechargeable battery 20 can be recharged by plugging in a recharging device into jack 45. A micro processor 26 controls the pump 16 and activates it when pressure switch 28 indicates that the tire 2 needs more air. A motion sensing switch 24 can tell the microprocessor if the vehicle is moving or not, and only use battery power when the vehicle is in motion. The entire housing is a uniform height from the tire rim 38 so that if the housing makes contact with a curb while parking, no portion of it protrudes more than another making the housing less likely to suffer damage. The housing is made of high impact plastic such as ABS or glass filled nylon.

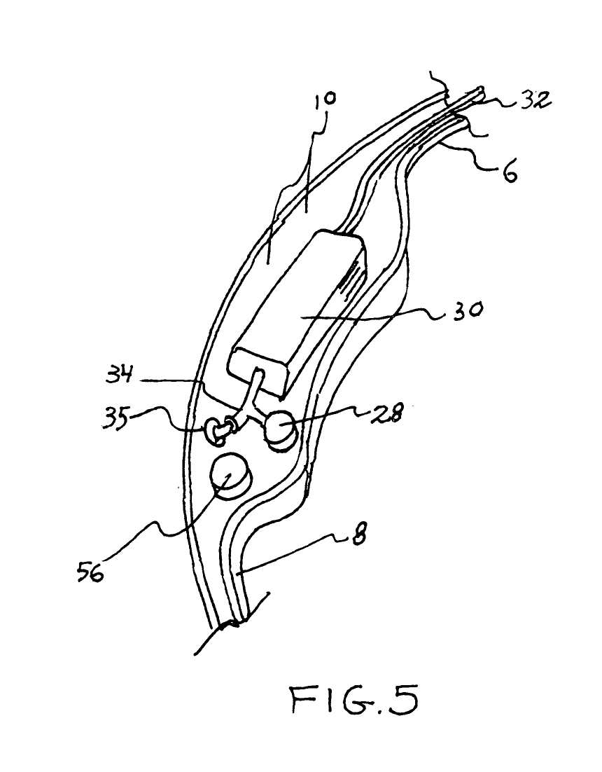

FIG. 5 shows a plan view of housing portion 10 with the top cover removed. extension tube 34 enters the bottom of the housing through a water resistant aperture gasket 35. Extension tube 34 attaches to pressure switch 28 as well as air pump 30. A lead weight 56 adds to the overall weight of housing portion 10 so that it is identical with the weight of housing portion 12 which contains rechargeable battery 20. The even weight distribution insures that the tire 2 will remain in balance after the invention 100 is installed. Electrical cable 62 travels through hollow track 6 and connects to printed circuit board 40.

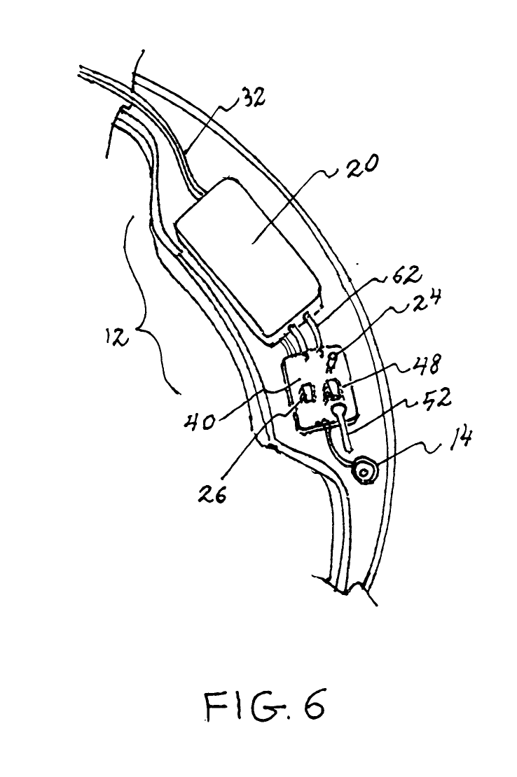

FIG. 6 shows a plan view of housing portion 12 which houses rechargeable battery 20 and printed circuit board 40 which holds micro processor 26, motion sensing switch 24 as well as optional transmitter 48 and antenna 52 which sends air pressure information to a standard receiver and digital display 70 mounted in a convent location on or near the dashboard of the vehicle.

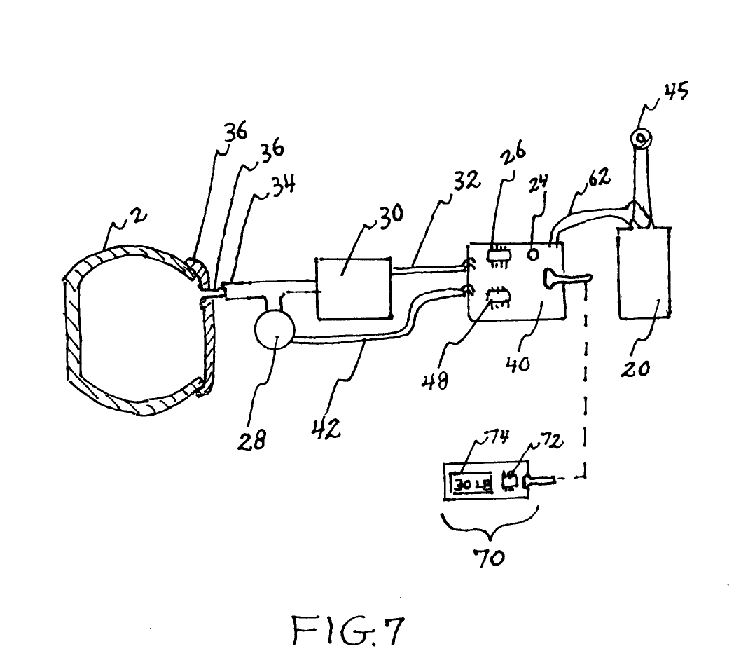

FIG. 7 is a schematic view of the automatic tire pressure system of the present invention. Standard rim 38 is attached to standard tire 2. Standard tire stem 36 protrudes from rim 38. Pneumatic stem connector tube 34 directs air from pump 30 into tire 2. Pressure switch 28 is in line with the outlet tube 44 of pump 30. Electrical cable 42 attaches pressure switch 28 to printed circuit board 40. Electrical cable 32 brings power to pump 30 via printed circuit board 40. Components micro processor 26, motion sensor 24, optional transmitter 38 and antenna 52 are mounted to printed circuit board 40. Transmitter antenna 52 sends a signal to receiver assembly 70 which contains a receiver microprocessor 72 and a digital display 74.

Similar automatic tire inflation systems 100 can be mounted to each wheel of a vehicle so that each wheel can maintain ideal air pressure while the vehicle is in motion.

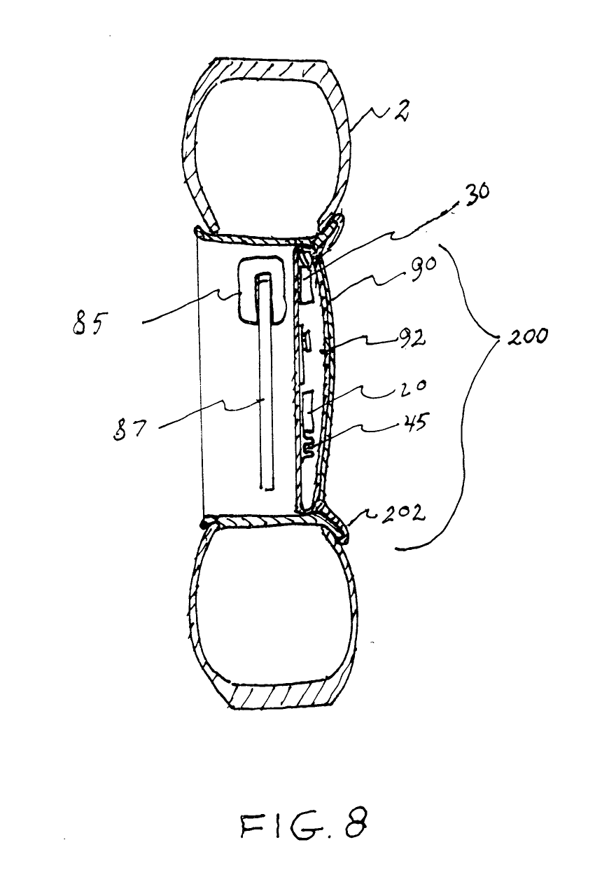

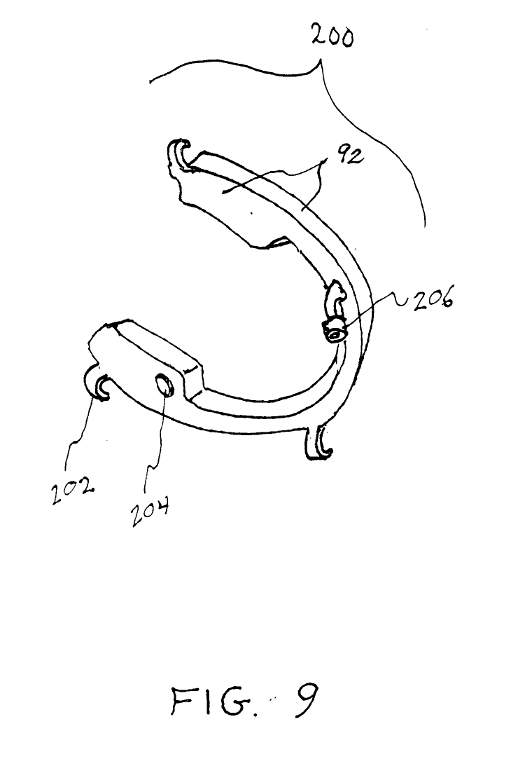

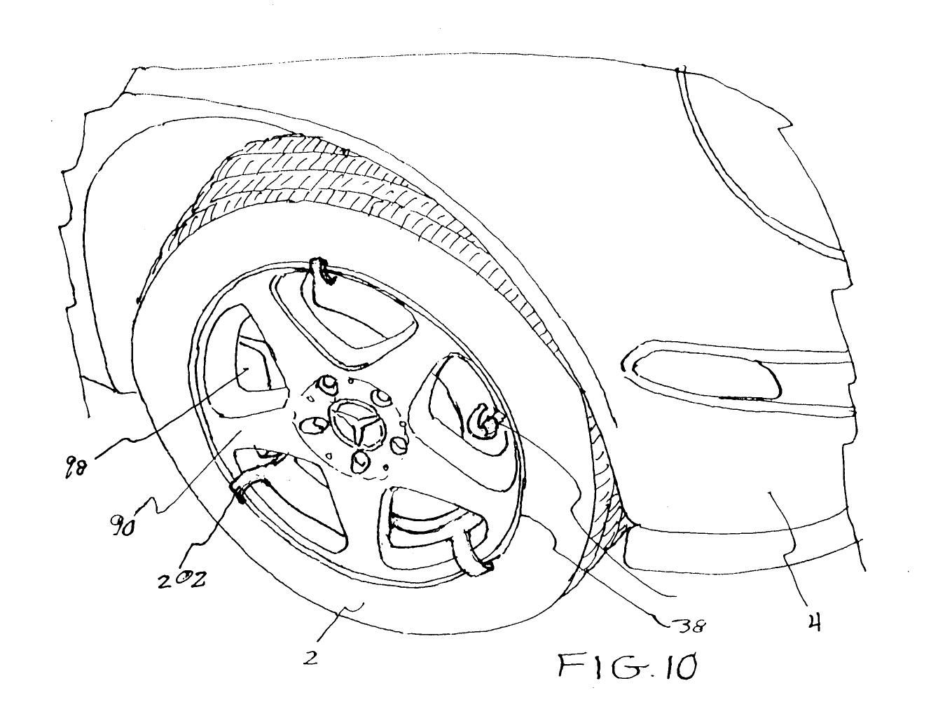

In an alternate, or second embodiment 200 is shown in FIGS. 8, 9 and 10. The section view in FIG. 8 shows a major housing portion 92, attached by rim retaining clips 202 to the tire rim in a similar way as the first embodiment. In second embodiment, all the components of the first embodiment, such as the pump 30, battery 20 and jack 45 are all housed in housing 92. The weight distribution of the components is the same as in the first embodiment thereby insuring a balanced rotation of the tire 2 during operation. In the second embodiment, each tire and rim has to be removed from the vehicle in order to insert the housing 92 between the central rim support 92 and the disk brake 87 and brake mechanism 85. Although this embodiment is more labor intensive to install, it has the advantage of not detracting from the outward appearance of the rim as shown in FIG. 10, and is less prone to being disturbed during the act of parking next to a curb. FIG. 9 shows a perspective view of the alternate embodiment 200.

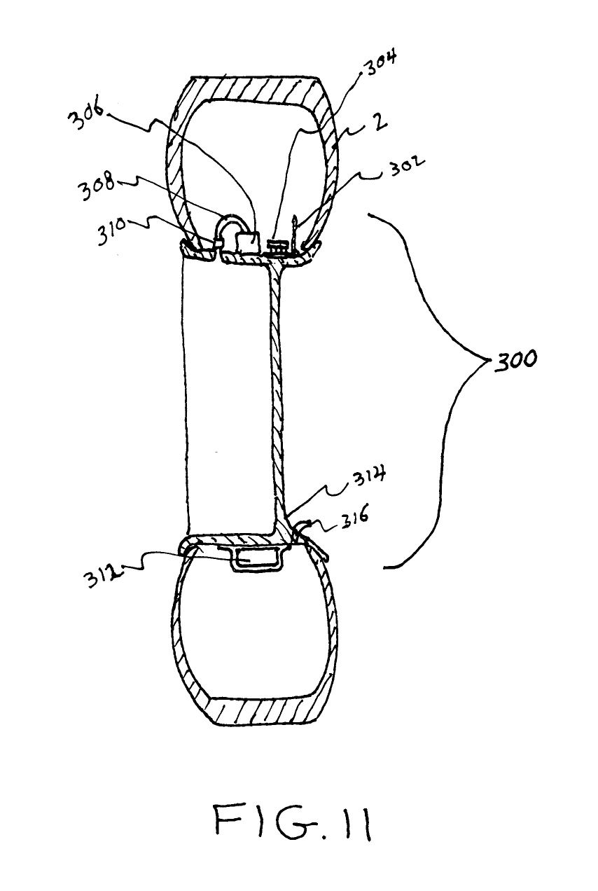

In a second alternate embodiment 300 shown in section view in FIG. 11, all the components described in the previous embodiments are enclosed within the inside tire portion 2 of the wheel. I check valve 310 lets air be drawn into pump 306 through tube 308 thereby filling the tire with the appropriate amount of air. The microprocessor 304 and pressure indicator 302 monitor air pressure inside the tire 2 and turn on pump 306 when the pressure is low. Battery 312 is attached to the rim 314 at the opposite side of the rim from the pump and electronics assembly so that there is equal weight on both sides of the rim thereby keeping the entire wheel assembly balanced in weight distribution. The battery 312 can be charged each time the tire is changed. The tire can also be pressurized in the normal means by attaching an air supply line to standard tire valve 316.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. automatic tire inflation system comprising:
a battery powered air pump;
an air pump electrical cable;
a pneumatic stem connector;
a pressure sensor switch;
a motion sensor switch;
a pressure sensor switch electrical cable;
a rechargeable battery power supply;
a recharging jack;
a waterproof jack cover;
a battery cable;
a microprocessor;
a printed circuit board;
a water resistant air filter;
a counter weight;
a water resistant hollow housing;
a plurality of rim retaining fingers;
said stem connector attached on one end to the stem of a standard vehicle tire and on the other end to said tire pressure switch;
said tire pressure switch pneumatically connected to said air pump; said pressure sensor switch electrical cable connected to said microprocessor;
said microprocessor mounted to said printed circuit board;
said motion sensor switch mounted to said printed circuit board;
said battery cable attached to said printed circuit board;
said air pump cable attached to said printed circuit board;
said hollow housing having an outside diameter conforming to the inside diameter of the rim of said vehicle tire;
said hollow housing having two major diametrically opposed portions connected by radial hollow track;
said hollow housing connected to said tire rim by said rim retaining fingers;
said air pump and said pressure switch housed in one said major housing portion;
said battery power supply and said printed circuit board with attached said components mounted on said opposing major housing portion;
said counter weight housed in the same said housing portion that contains said air pump;
said counter weight being sized to make the weight of said air pump housing portion equal to that of said battery containing housing portion;
said housing having a uniform height from said tire rim on both said major housing portions and on said connecting radial hollow tracks;
said housing having an aperture that accepts said recharging jack;
said aperture and said recharging jack having a removable and replaceable waterproof cover;
said housing having an air passage aperture;
said water resistant air filter inserted into said air passage aperture;
said microprocessor monitoring air tire pressure being sent from said pressure sensor and activating said air pump when said pressure is determined to be too low by said microprocessor;
said air pump turning off when said air tire pressure reaches a predetermined set point;
said rechargeable battery capable of being recharged by a standard charging device attached by a plug to said recharging jack;
said motions sensor switch turning on said microprocessor when said vehicle is in motion and off when not in motion; and
said vehicle having similar automatic tire inflation systems mounted to each tire of the vehicle.

2. An automatic tire inflation system as claimed in claim 1 further comprising a transmitter and antenna assembly attached to said printed circuit board within said hollow housing;
a standard receiving circuit and antenna mounted in a second housing;
said second housing attached to a location on or near the dashboard of the vehicle having said automatic tire inflation system;
a digital readout mounted in said second housing and readable through an aperture in said second housing so that a person driving said vehicle can read and monitor the air pressure of the tires of said vehicle.

3. An alternate embodiment to the automatic tire inflation system as claimed in claim 1 wherein the water resistant hollow housing is placed on the inside surface of said tire rim between the rim and the disk brake.

4. A second alternate embodiment to the automatic tire inflation system as claimed in claim 1 wherein all said pumping and electronic components are fixedly attached to the inside wall of a specially designed tire rim so that all said components are installed within said vehicle tire.
